(19) United States
(12) Patent Application Publication
(10) Pub. No.: US 2006/0138815 A1
(43) Pub. Date: Jun. 29, 2006

(54) Forward position bicycle passenger seat

(76) Inventors: Gabriel R. Sosa III, Panama City (PA); John A. Scialdone, Diamondhead, MS (US)

Correspondence Address: John A. Scialdone, PO Box 130, Gulfport, MS, 39502, US

(21) Appl. No.: 11/159,071

(22) Filed: Dec. 20, 2004

(51) Int. Cl. B62J 1/00

(52) U.S. Cl. 297/195.13

(57) ABSTRACT

A passenger bicycle seat which supports a passenger on a bicycle and it mounted forward of the operator's seat and is mounted by a box plate. The passenger bicycle seat has stationary foot pedals and a T bar handle grip for the passenger. The passenger bicycle seat is secured by a box plate along to the bicycle frame to prevent movement fore and aft, and from side to side.

### CROSS REFERENCE TO RELATED APPLICATIONS

1. None.

### STATEMENT REGARDING FEDERALLY-SPONSORED RESEARCH AND DEVELOPMENT

Not Applicable.

### REFERENCE TO APPENDIX

Not Applicable.

### BACKGROUND OF THE INVENTION

This invention relates to bicycles, and more particularly, to a passenger bicycle seat which comfortably supports a passenger in front of the operator's bicycle seat, requires almost no assembly, and is very easy to install.

### BRIEF SUMMARY OF THE INVENTION

A passenger bicycle seat which is forward of the operator's bicycle seat and mounted to a box plate. The passenger bicycle seat includes stationary foot pedals and a T bar handle grip for the comfort of the passenger. This passenger bicycle seat is secured by a box plate to prevent movement fore and aft, and side to side, along the bicycle frame as shown in FIGS. 1-4.

### BRIEF DESCRIPTION OF THE SEVERAL VIEWS OF THE DRAWINGS

The objects of the invention are achieved as set forth in the illustrative embodiments shown in the drawings which form a part of the specification

FIG. 1 is a diagram of the working model illustration of a normal bike seat mounted to a 17″ metal box plate. The passenger bike seat is mounted to the forward section of the box plat which is 17″ in length and 4″ in width and 2″ in depth. The working model depicts stationary 4″ pedals affixed to the forward section of the set and box plate and are attached to two 9″ long metal pipes sitting at 90° from the seat and box plate assembly.

FIG. 2 is a diagram of the passenger bike seat with attached 4″ pedals.

FIG. 3 is a diagram of the passenger bicycle seat with the attached T bar handle grips which is mounted to the box plate assembly.

FIG. 4 is a diagram of the passenger bike seat mounted to a bicycle.

### DETAILED DESCRIPTION OF INVENTION

The item consists of a passenger bicycle seat to be located forward of the bicycle operator's seat, and mounted to a 17″ metal box plate. The passenger seat is itself mounted to the forwarded section of the box plate with the box plate having dimensions of 17″ in length, 4″ width and 2″ depth. The aft section of the box plate is outfitted with a 2″ inch by 1½″ opening located in the mid-section of the box plate and through which the mounting shaft for the operator's seat support shaft passes, so as to lock the passenger seat box plate assembly into position along the bicycle frame and at a set location forward of the operator's seat. Located directly behind the passenger seat, and mounted to the bottom of the box plate on each opposing side, is a two inch bolt used to further secure the seat and box plate assembly and prevent side-to-side movement. The pair of 2″ bolts located directly behind and underneath the rider's seat and the 2″ by 1½″ opening in the top surface of the forward section of the seat and box plate assembly, serve in conjunction to prevent movement fore and aft, and side to side, along the bicycle frame. Affixed to the forward section of the seat and box plate assembly, are two 9″ long metal pipes sitting at 90° from the seat and box plate assembly and to the end of which are fastened stationary foot pedals. A T bar handle grip is attached to the mounting shaft.

Having thus described the invention, what is claimed and desired to be secured by Letters Patent is:

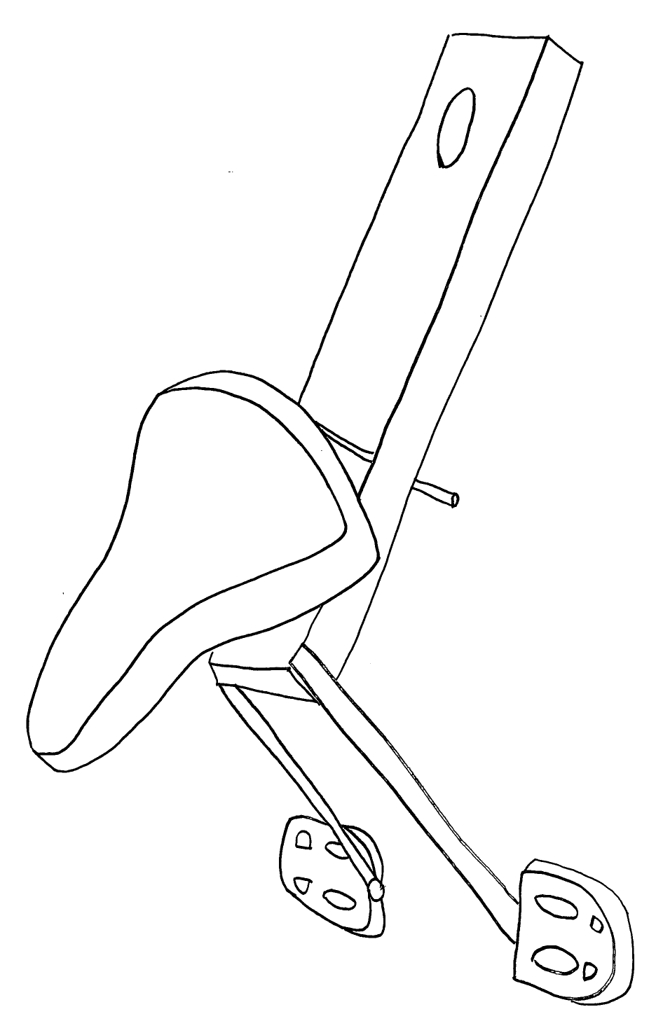

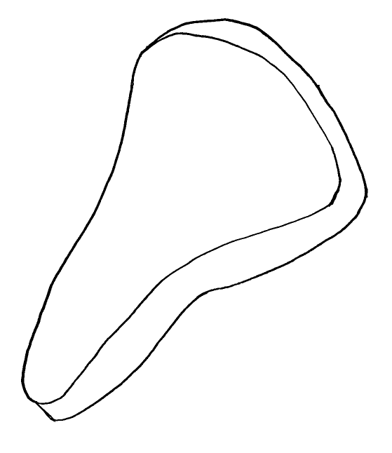

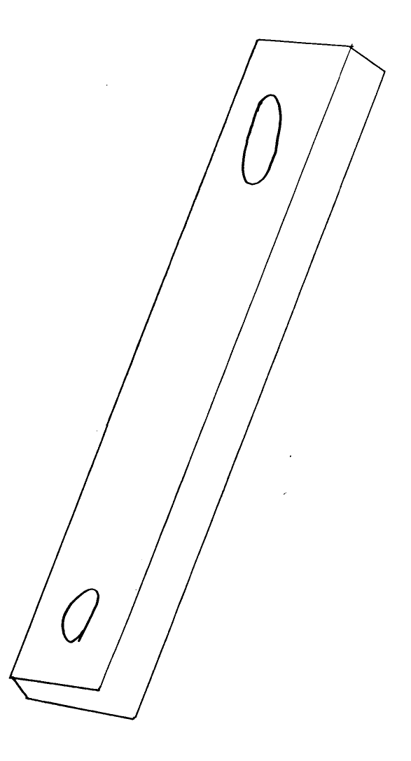

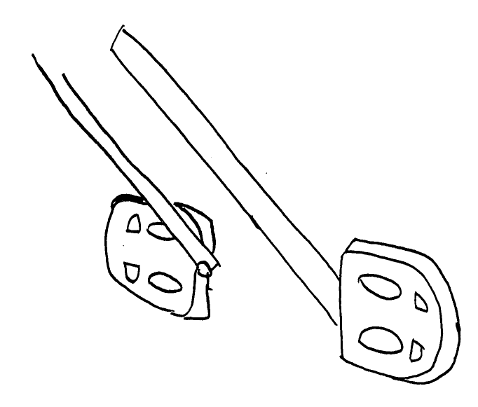

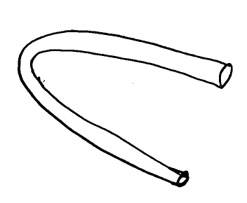

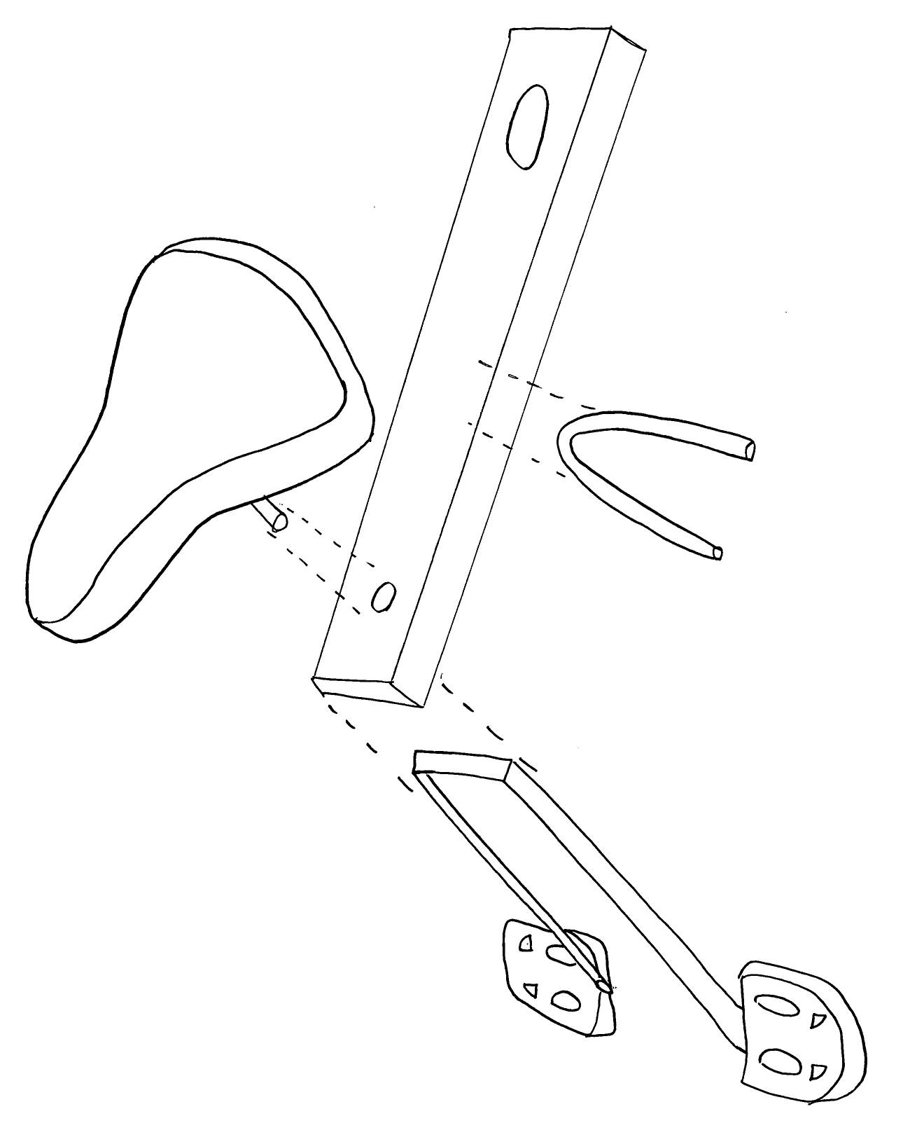

1. A passenger bicycle seat to be located forward of the bicycle operator's seat, and mounted to a metal box plate that is slotted to fit into the shaft of the operator's seat, and with the underlying support resting on the frame, with a T-bar handle, as shown by FIGS. 1-4. The passenger bicycle seat is equipped with stationary foot pedals and a T bar handle grip to support the passenger, as shown in the figures.
